(19) United States
(12) Patent Application Publication
(10) Pub. No.: US 2007/0200326 A1
(43) Pub. Date: Aug. 30, 2007

(54) GAS GENERATOR FOR RESTRAINING DEVICE FOR VEHICLE

(75) Inventors: Masayuki Nakayasu, Tatsuno-Shi (JP); Naoki Matsuda, Tatsuno-Shi (JP)

Correspondence Address: BIRCH STEWART KOLASCH & BIRCH, PO BOX 747, FALLS CHURCH, VA, 22040-0747, US

(73) Assignee: Daicel Chemical Industries, Ltd., Sakai-shi (JP)

(21) Appl. No.: 11/677,978

(22) Filed: Feb. 22, 2007

Related U.S. Application Data
(60) Provisional application No. 60/777,527, filed on Mar. 1, 2006.

(30) Foreign Application Priority Data
Feb. 24, 2006 (JP) 2006-47709

(51) Int. Cl. B60R 21/26

(52) U.S. Cl. 280/736; 280/737; 280/740; 280/742

(57) ABSTRACT

The present invention provides a gas generator for an restraining device for a vehicle comprising: a cylindrical housing having two open sections; an ignition device chamber connected to one open section of the cylindrical housing; a diffuser portion connected to the other open section of the cylindrical housing and provided with a gas discharge port; a first blockage member blocking between the cylindrical housing and the ignition device chamber; a second blockage member blocking between the cylindrical housing and the diffuser portion; pressurized gas charged inside the cylindrical housing; a rod for breaking the second blockage member upon activation and opening a channel to the diffuser portion; and the rod being disposed inside the cylindrical housing in the state that a base end portion of the rod contacts a wall surface in the vicinity of the first blockage member and a distal end portion of the rod is integrated with a retainer fitted into a position close to the second blockage member.

This nonprovisional application claims priority under 35 U.S.C. §119(a) on Patent Application No. 2006-47709 filed in Japan on 24 Feb. 2006 and 35 U.S.C. §119(e) on U.S. Provisional Application No. 60/777527 filed on 1 Mar. 2006, which are incorporated by reference.

### BACKGROUND OF INVENTION

1. Field of Invention

The present invention relates to a gas generator for use in an restraining device for a vehicle, such as an airbag system, an inflatable seat belt, and a pedestrian protection device, and to a method for assembling the gas generator.

2. Description of Related Art

In a gas generator for inflating an airbag or the like in an occupant restraining device for a vehicle or a pedestrian protection device, a structure in which an igniter or the like to be connected to an ignition lead wire does not exists in the vicinity of a gas discharge port is preferable because the ignition lead wire becomes an obstacle at the time of connecting an air bag (restraining device) to the gas discharge port.

JP-B No. 3,562,020 discloses an inflator using a pressurized gas, wherein an igniter and a gas discharge port are separated. In this structure, a gas discharge channel is opened by rupturing a blockage plate that blocks the gas discharge port by propelling a projectile for breaking the blockage plate. In the structure disclosed in JP-B No. 3,562,020, the projectile for breaking the blockage plate is held with a holding member disposed inside a gas storage unit.

### SUMMARY OF INVENTION

The present invention provides a gas generator for an restraining device for a vehicle including:

a cylindrical housing having two open sections;

an ignition device chamber connected to one open section of the cylindrical housing;

a diffuser portion connected to the other open section of the cylindrical housing and provided with a gas discharge port;

a first blockage member blocking between the cylindrical housing and the ignition device chamber;

a second blockage member blocking between the cylindrical housing and the diffuser portion;

pressurized gas charged inside the cylindrical housing;

a rod for breaking the second blockage member upon activation and opening a channel to the diffuser portion; and

the rod being disposed inside the cylindrical housing in the state that a base end portion of the rod contacts a wall surface in the vicinity of the first blockage member and a distal end portion of the rod is integrated with a retainer fitted into a position close to the second blockage member.

The present invention also provides a 1st method for assembling the above shown gas generator for an restraining device, including a step of integrating the rod and the retainer and then inserting the integrated rod and retainer into the cylindrical housing.

In other words, the 1st method includes:

providing a cylindrical housing having two open sections;

connecting an ignition device chamber to one open section of the cylindrical housing, which includes a first blockage member blocking a first channel between the cylindrical housing and the ignition device chamber;

integrating a rod, which includes a base end portion formed at one end thereof and a distal end portion formed at the other end thereof, with a retainer that has an orifice and supports the distal end portion of the rod; and

providing the rod and the retainer within the cylindrical housing.

The present invention also provides a 2nd method for assembling the above shown gas generator for an restraining device, provided that the retainer has an orifice, the distal end portion of the rod has a through section that passes through the orifice and a non-through section that does not pass through the orifice, and a circumference of the orifice is sandwiched between the through section and the non-through section, thereby integrating the rod and the retainer, including steps of:

using a rod which has a distal end portion composed of a non-through section having a diameter larger than a diameter of the orifice in the retainer and a through section having a diameter smaller than the diameter of the orifice in the retainer;

integrating the rod and the retainer by inserting the through section into the orifice in the retainer, then crimping the through section to sandwich the circumference of the orifice between the non-through section and the through section; and

processing the through section into a shape which break the second blockage member easily; inserting the integrated rod and retainer into the cylindrical housing.

In the 2nd method, in other words, a rod comprising a distal end portion having a non-through section with an outer diameter larger than the diameter of the orifice of the retainer and a through section with an outer diameter smaller than the diameter of the orifice of the retainer is used as the rod, the method including steps of inserting the through section into the orifice of the retainer and crimping the through section, thereby sandwiching a circumference of the orifice by the non-through section and the through section to integrate the rod and the retainer; machining the through section to a shape that easily fracture the second blockage member; and inserting the integrated rod and retainer into the cylindrical housing.

In the 2nd method, in other words, the step of integrating the rod with the retainer includes,

integrating the retainer and the rod that is provided with a non-through section having a diameter larger than a diameter of the orifice of the retainer, and through section having a diameter smaller than the diameter of the orifice;

inserting the through section into the orifice;

crimping the through section to sandwich a circumference of the orifice between the non-through section and the through section.

### BRIEF DESCRIPTION OF THE DRAWINGS

The present invention will become more fully understood from the detailed description given hereinbelow and the accompanying drawings which are given by way of illustration only, and thus are not limitative of the present invention and wherein:

FIG. 1(a) shows a vertical cross-sectional view of the gas generator; FIG. 1(b) shows a partial view of FIG. 1(a);

FIG. 2 shows a perspective view of the retainer shown in FIG. 1;

FIGS. 3(a) to (c) illustrate a method for integrating the retainer and rod;

FIG. 4(a) shows a vertical partial cross-sectional view of the gas generator of another embodiment; FIG. 4(b) shows a partial view of FIG. 4(a); and

FIG. 5 shows a perspective view of the retainer used in the gas generator shown in FIG. 4.

### DETAILED DESCRIPTION OF INVENTION

The present invention provides a gas generator for an restraining device for a vehicle in which an igniter and a gas discharge port are provided in separate positions and blockage member of a gas discharge channel leading to the gas discharge port is fractured with a rod, wherein the rod is fixed reliably.

When a gas generator is actuated, the first blockage member is broken by the ignition device, the second blockage member is broken by the rod, and the gas discharge channel leading to the gas discharge port is then opened. As a result the airbag is inflated and the restraining device is operated. From the standpoint of ensuring the safety of passengers, this operation has to be reliably performed for over 10 years, which is the service life of a vehicle. Therefore, such a case should not be happened that the rupture of the second blockage member is prevented because of the rod being separated or displaced by vibrations applied from the outside.

In accordance with the present invention, the rod and the retainer are separate members, but they are disposed inside the cylindrical housing, being combined and integrated with each other. The term “integrated” as used herein indicates that the rod and retainer are joined at least partially, form as a whole a single member, and are used as such a single member when the gas generator is assembled. The integrated state of the rod and retainer is maintained when the gas generator is assembled and before the actuation of the gas generator, and this state is released during actuation.

The center of the rod and the center of the second blockage member are preferably disposed to coincide with each other in order to rupture the second blockage member reliably, but if the rod and retainer are in an integrated state, the aforementioned centers can be coincided easily.

It is preferred that the retainer have a cross-sectional shape identical to the cross-sectional shape of the cylindrical housing in the width direction and can be press-inserted into the cylindrical housing. The cross section of the cylindrical housing in the width direction preferably has a round shape, but may also have a polygonal or elliptical shape.

The expression “distal end portion of the rod” indicates a portion of the rod that directly participates in fracturing the second blockage member (portion that comes into contact with the second blockage member during fracture) and the proximity thereof.

Prior to actuation, the distal end portion of the rod is preferably disposed at a distance from the second blockage member, but may be also in contact therewith. By providing a spacing between the distal end portion of the rod and the second blockage member, an initial speed is generated when the distal end portion of the rod comes into contact with the second blockage member, thereby facilitating the fracture of the second blockage member.

In order to facilitate the fracture of the second blockage member, the distal end portion of the rod is preferably sharpened to have the shape of an arrowhead, but may also have a flat surface or a semispherical shape. When the distal end portion of the rod is sharpened to have the shape of an arrowhead, the angle of the arrowhead is preferably within the range of 45° to 150°. When the distal end portion of the rod is a flat surface, the second blockage member should be easily fractured by shearing. Therefore, it is preferred that the boundary portion between the shaft portion and distal end portion of the rod have an angle (preferably, the angle between the flat surface and the surface (side surface) that is adjacent to the flat surface) of 90° or an angle close thereto.

The cross-sectional area of the rod in the width direction preferably has a round shape, but may have a polygonal shape. A diameter of the rod is the diameter of the circle in the case of a round shape. In the case of a polygonal shape, the rod diameter is the length of a diagonal when the polygon is a quadrangle or hexagon. The diameter is a maximum length when the polygon is a pentagon.

An ignition device including an electric igniter is used as the ignition device accommodated in the ignition device chamber and rupturable plates formed from stainless steel or iron can be used as the first and second blockage members, all of which has been used in the well-known gas generators.

The present invention preferably provides the gas generator for an restraining device for a vehicle, wherein the retainer has an orifice, the distal end portion of the rod has a through section that passes through the orifice and a non-through section that does not pass through the orifice, and a circumference of the orifice is sandwiched between the through section and the non-through section, thereby integrating the rod and the retainer.

In the distal end portion of the rod, the through section has an outer diameter smaller than the diameter of the orifice in the retainer, and the non-through section has an outer diameter larger than the diameter of the orifice in the retainer, whereby a step (stepped surface) is created between the non-through section and through section. Therefore, the distal end portion of the rod and the retainer are brought into contact with the circumference of the orifice in the retainer, the through section is positioned on one side of the orifice, and the non-through section is positioned on the opposite side of the orifice.

As a method for sandwiching the circumference of the orifice between the through section and non-through section, a method by which the through section having an outer diameter smaller than the diameter of the orifice is passed through the orifice of the retainer, the through section is then deformed to be crushed (for example, deformed by crimping as described above), and the outer diameter of the through section is made larger than the diameter of the orifice, or a method by which a cap-shaped or annular pressing member having an inner diameter matching the outer diameter of the through section is inserted or screwed into the through section can be employed.

Combining the distal end portion of the rod and the orifice of the retainer in the above-described manner facilitates the integration of the rod and retainer. Furthermore, by performing an adjustment during integration such that the positions of the center of the distal end portion of the rod and the center of the orifice in the retainer coincides with each other, the alignment of the center of the distal end portion of the rod and the center of the second blockage member is facilitated.

The present invention preferably provides the gas generator for an restraining device for a vehicle, wherein the retainer has an orifice, the distal end portion of the rod has a through section that passes through the orifice and a non-through section that does not pass through the orifice, an annular groove is formed between the through section and the non-through section, and a circumference of the orifice is inserted into the annular groove to integrate the rod and the retainer.

The through section and non-through section of the distal end portion of the rod have an outer diameter larger than the diameter of the orifice in the retainer. The diameter of the annular groove between the through section and non-through section is equal to or less than the diameter of the orifice in the retainer, and the width of the annular groove is almost equal to the thickness of the circumferential portion of the orifice of the retainer.

As a method of inserting the circumference of the hole in the retainer into the groove, the retainer or the circumference of the orifice of the retainer is formed from a member having high elasticity, the distal end portion of the rod is pushed in, while deforming the orifice of the retainer, and the pushing process is stopped when the annular groove reaches the position of the orifice of the retainer. Additionally, the method can be also employed such that the through section is deformed to be crushed (for example, deforming by crimping as described above), whereby the circumference of the orifice of the retainer is inserted into the annular groove formed between the through section and non-through section.

Combining the distal end portion of the rod and orifice of the retainer in the above-described manner facilitates the integration of the rod and retainer. Furthermore, by adjusting, during integration, such that the positions of the center of the distal end portion of the rod and the center of the orifice in the retainer match each other, the alignment of the center of the distal end portion of the rod and the center of the second blockage member is facilitated.

The present invention preferably provides the gas generator for an retraining device, wherein the retainer is formed from a member having elastic properties, the rod is fixed in the state of having a base end portion thereof in contact with a wall surface in the vicinity of the first blockage member and being pressed against the wall surface in the vicinity of the first blockage member due to elastic deformation of the retainer, and the distal end portion of the rod and retainer are fixed by pressing against each other.

The distal end portion of the rod and the retainer are integrated, for example, in a state where the rod and retainer are pressed against each other. In other words, they are integrated so that the retainer presses the rod against the wall surface in the vicinity of the first blockage member, whereas the rod presses the retainer toward the second blockage member. The retainer is thus fixed inside the housing so that the retainer does not move in response to the pressing pressure created by the rod.

By fixing the rod and retainer in the above-described manner, the base end portion of the rod is fixed by being pressed against the wall surface in the vicinity of the first blockage member. Therefore, the rod is supported at the distal end portion and base end portion, and prevented from falling or shifting. In particular, because the distal end portion of the rod is integrated with the retainer, fixing the retainer makes it possible to fix the distal end portion of the rod in the radial direction and axial direction. Further, because the base end portion of the rod is pressed against the wall surface in the vicinity of the first blockage member by the elastic force of the retainer, the base end portion of the rod can be fixed in a simpler manner (the base end portion of the rod is just prevented from shifting in the radial direction).

A fragile portion can be provided in the portion where the distal end portion of the rod and the retainer are integrated, so that this portion can be reliably broken by a smaller force when the gas generator is actuated. The fragile portion, as referred to herein, is a section having a thickness smaller than that of other portions, a portion having a groove formed therein, or a notched portion. When a force is applied, this portion is deformed, cleaved, and broken prior to other portions, thereby canceling the integration of the rod and retainer and allowing the rod to move toward the second blockage member. The fragile portion can be formed either on the retainer side or on the rod side.

The present invention preferably provides the gas generator for an restraining device for a vehicle, wherein the retainer has an annular frame portion, a plurality of rod-like supporting portions that extend from a peripheral edge on one end side of the annular frame portion toward the center, and a central supporting portion formed by the plurality of rod-like supporting portions, and the central supporting portion has an orifice in which the distal end portion of the rod is to be inserted.

Because of a shape having an open portion surrounded by the annular frame portion, central supporting portion, and rod-like supporting portions, an elastic force can be easily generated by these central supporting portion, rod-like supporting portions, and annular frame portion. The annular frame portion, central supporting portion, and rod-like supporting portions may have any shape, provided that the aforementioned elastic force is generated.

By using such a retainer, when the integrated rod and retainer are inserted or press-inserted into the cylindrical housing to be disposed therein, at least one of the annular frame portion, central supporting portion, and rod-like supporting portions is bent toward the second blockage member and the rod is pressed against the first blockage member by the reaction force thereof. As a result, the rod and retainer can be fixed easily. Because the elastic force of the retainer is thus exhibited, the rod is prevented from separating or shifting even when external vibrations are applied.

Further, the retainer weight can be reduced because of the open portion present therein, and the open portion also acts to facilitate the passage of the pressurized gas. Therefore, the total area of the open portion is set to be larger than the maximum cross section area of the gas discharge channel from the retainer to the gas discharge port and the total open area of the gas discharge port.

Because the rod and retainer are disposed inside the cylindrical housing after being integrated to be a single part, the center of the distal end portion of the rod and the center of the second blockage member can be matched easily. Furthermore, the assembly of the gas generator is also facilitated.

In the rod that is used in the invention, the through section has an outer diameter less than the diameter of the orifice in the retainer, the non-through section has an outer diameter larger than the diameter of the orifice of the retainer, and a step (stepped surface) is present between the non-through section and through section due to the difference in the outer diameters between the non-through section and through section. As a result, when the distal end portion of the rod is inserted into the orifice of the retainer, the stepped surface abuts against the circumference of the orifice, the through section is positioned on one side of the orifice, and the non-through section is positioned on the opposite side of the orifice.

The step of integrating the rod and retainer and the subsequent step of processing the through section can be implemented as a single continuous process. For example, by applying a rolling-crimping method, the through section is deformed to be crashed in the axial direction and/or outwardly radial direction, whereby the circumference of the orifice of the retainer is sandwiched between the through section and non-through section, the distal end portion of the rod and retainer are integrated, and the distal end portion is deformed into a shape that can easily fracture the second blockage member. The distal end portion of the rod can be in the shape of an arrowhead, a flat surface, or a hemisphere.

The rolling-crimping method is a processing method in which a rotary rod-like tool (a tool having a roller at the tip end, and this roller rotates) is pressed against the entire perimeter of the circumferential surface of the through section, whereby this portion is deformed.

Because the rod and retainer are disposed inside the cylindrical housing after being integrated, the center of the distal end portion of the rod and the center of the second blockage member can be matched easily. Furthermore, the assembly of the gas generator is also facilitated.

In the gas generator in accordance with the present invention, the rod and retainer can be fixed more easily, and the gas generator also can be assembled more easily. Furthermore, because the rod and retainer are prevented from being displaced or falling off by vibrations applied from the outside, the high product reliability is obtained.

### Preferred Embodiments of Invention

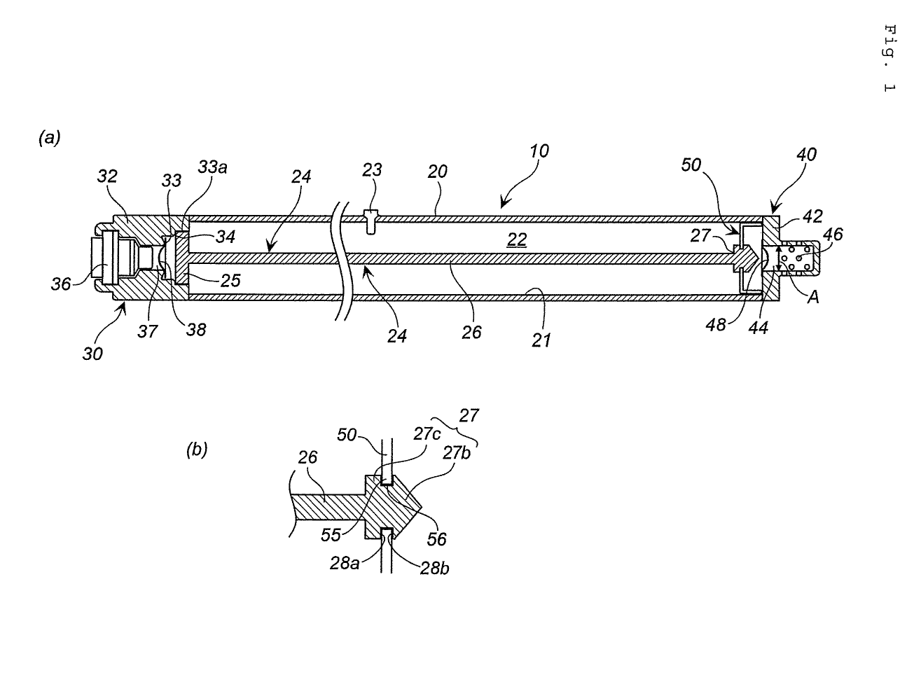

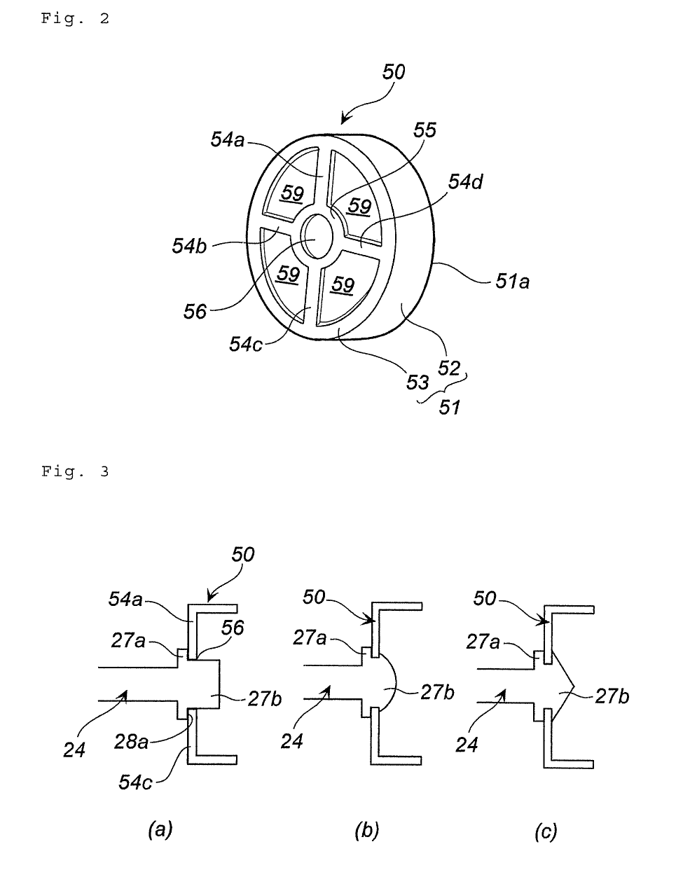

(1) Gas Generator Shown in FIG. 1 and FIG. 2

FIG. 1(a) is a vertical cross-sectional view of a gas generator 10 for an airbag. FIG. 1(b) is a partially enlarged view of FIG. 1(a). FIG. 2 is a perspective view of a retainer shown in FIG. 1(a). FIG. 3 illustrates a method for integrating the retainer and rod shown in FIG. 1(a).

The cylindrical housing 20 has two open sections at both ends thereof and has an ignition device chamber 30 connected to the open section at one end and a diffuser portion 40 connected to the open section at the other end. The chamber and diffuser portion are made from stainless steel or aluminum and fixed by welding in the respective joint sections thereof.

An inner space 22 of the cylindrical housing 20 is maintained in an air-tight state and filled with a single kind of gas such as argon, helium, nitrogen, or mixture thereof (filling pressure is about 35,000 to 70,000 kPa). The pressurized gas preferably has a sound velocity of 400 mm/sec or more at 0° C. and 1 atm (101.325 kPa). The pressurized gas is supplied from a charging port before it is closed with a pin 23. The port is sealed by welding the pin 23 and the cylindrical housing 20 together.

An outer shell of the ignition device chamber 30 is formed by an ignition device chamber housing 32. An electric igniter 36 including an ignition agent is accommodated inside the ignition device chamber housing 32. The igniter 36 is connected to a power supply circuit of a vehicle via a connector and a lead wire (not shown in the drawings). The igniter 36 includes 260 mg of ignition agent composed of zirconium and potassium perchlorate as the main components.

A first channel 37 between the cylindrical housing 20(inner space 22) and ignition device chamber 30 is blocked by a first rupturable plate 38 made from stainless steel, and the inside of the ignition device chamber 30 is under a normal pressure. The circumferential edge section of the first rupturable plate 38 is fixed by welding to a first annular stepped surface 33 provided on the inner surface of the ignition device chamber housing 32.

The outer shell of the diffuser portion 40 is formed by a diffuser housing 42. A plurality of gas discharge ports 46 for discharging the pressurized gas to the outside are disposed equidistantly in the diffuser housing 42. In the present embodiment, a total of 30 gas discharge ports 46 having the diameter of 1.5 mm are formed (the total open area thereof is 53 mm²).

A second channel 44 between the cylindrical housing 20 (inner space 22) and diffuser portion 40 is blocked with a second rupturable plate 48 made from stainless steel, and the inside of the diffuser portion 40 is maintained under a normal pressure. The circumferential edge section of the second rupturable plate 48 is fixed by welding to the diffuser housing 42. Furthermore, a rod 24 is disposed inside the cylindrical housing 20 (inner space 22) to rupture the second rupturable plate 48. The cross-section diameter (A) of the second channel is 8 mm (cross section area 50 mm²).

A retainer 50 is disposed in the vicinity of the diffuser portion 40 inside the cylindrical housing 20.

The retainer 50 shown in FIG. 2 has an annular frame portion 51 having a circumferential surface section 52 and an annular surface section 53, a plurality of rod-like supporting portions 54a, 54b, 54c, 54d extending from the annular surface section 53 toward the center, and a central supporting portion 55 having a orifice 56 and linked to the rod-like supporting portions 54a to 54d. The retainer 50 is made from a metal such as stainless steel, aluminum or a synthetic resin and has elastic properties. Because the central supporting portion 55 is a fragile portion, it can be fractured easier than other portions.

The retainer 50 has four open portions 59 surrounded by the annular frame portion 51 (annular surface section 53), central supporting portion 55 and rod-like supporting portions 54a, 54b, 54c, 54d. The total open area of the four open portions 59 is 60 mm².

The rod 24 has a disk portion (base end portion) 25, a shaft portion 26, and a distal end portion 27. The distal end portion 27 has a non-through section 27a and a through section 27b in the form of an arrowhead. All the portions are integrated and made from a metal such as stainless steel or aluminum.

The disk portion 25 abuts against a second annular stepped surface 34 provided on the inner surface of the ignition device chamber housing 32. In FIG. 1(a), the first rupturable plate 38 and disk portion 25 are separate members, but the disk portion 25 and first rupturable plate 38 may be formed integrally, and the disk portion 25 may also serve as the first rupturable plate 38. Further, in order to facilitate the movement of the rod 24 upon the actuation of the igniter, the outer peripheral surface of the disk portion 25 is such that the movement thereof in the radial direction is prevented by the circumferential wall section 33a of the housing 32.

In the distal end portion 27, the non-through section 27a and through section 27b are disposed on one side of the orifice 56 and on the opposite side in the axial direction respectively, and the central supporting portion 55 having the orifice 56 is sandwiched from both sides by the first contact surface 28a located on the non-through section 27a and a second contact surface 28b located on the through section 27b.

The rod 24 and retainer 50, that are integrated at the distal end portion 27 of the rod 24 and the central supporting portion 55 of the retainer 50, are press-inserted into the cylindrical housing 20. The circumferential edge section 51a of the retainer 50 is abutted against the diffuser housing 42 and prevented from moving in the direction of the second rupturable plate 48. Because the center of the orifice 56 and the center of the second rupturable plate 48 are directly opposite to each other, the center of the distal end portion 27 (the apex of the arrowheadlike through section 27b) and the center of the second rupturable plate 48 are also directly opposite to each other.

Because the rod 24 and retainer 50 that are thus integrated are press-inserted into the cylindrical housing 20, the rod-like supporting portion 54a, etc., central supporting portion 55, or annular frame portion 51 is deformed so as to be deflected toward the second rupturable plate 48. Because the retainer 50 has elastic properties, the rod 24 is pressed in the direction of the first rupturable plate 38 by the restoration force generated when the rod-like supporting portion 54a, etc., central supporting portion 55, or annular frame portion 51 is deformed. On the other hand, the retainer 50 is pressed by the rod 24 in the direction of the second rupturable plate 48 (however, the retainer 50 abuts against the diffuser housing 42, so that the retainer does not move toward the second rupturable plate 48), and therefore, the rod 24 and retainer 50 are pressed against each other to be fixed.

The rod 24 and retainer 50 are thus sandwiched between the ignition device chamber housing 32 and diffuser housing 42. As a result, both the retainer 50 and the rod 24 are fixed in the prescribed position, the displacement of the rod 24 under the effect of vibrations induced from the outside is prevented, and both the displacement and falling-off of the retainer 50 itself are also prevented.

The operation of the gas generator 10 shown in FIG. 1 and FIG. 2 when it is incorporated into an airbag system of an automobile will be described below.

When an automobile collides and receives the impact, upon receiving an actuation signal from a control unit, the igniter 36 is actuated and ignited to produce the shock wave, which ruptures the first rupturable plate 38 to open the first channel 37. The shock wave that ruptures the first channel 37 then collides with the disk portion 25 of the rod and pushes the rod 24 toward the diffuser portion 40.

As a result, the rod 24 moves in the axial direction, the distal end portion 27 that has been inserted into the orifice 56 fractures the central supporting portion 55 in the retainer 50 shown in FIG. 2, moves straight forward and collides with the second rupturable plate 48.

The distal end portion 27 (through section 27b) is pointed, and therefore, when it collides with the central portion of the second rupturable plate 48, the second rupturable plate 48 is ruptured in a petal-like fashion from the central portion. Therefore, the circumferential edge section is integrated with the main body of the rupturable plate 48 and no fragments are produced.

In the case of FIG. 2, the orifice 56 itself is a fragile portion, but a fragile portion can be obtained by forming a portion that is thinner than the retainer 50 (central supporting portion 55) on the outer side of the orifice 56, or by forming partial cuts, grooves or notches. Further, the non-through section 27a of the distal end portion 27 of the rod may be formed as a thinner fragile portion that can be easily fractured.

If the second rupturable plate 48 is thus cleaved in a petal-like fashion from the central portion thereof and the second channel 44 is opened, the pressurized gas is discharged from the gas discharge ports 46 and the air bag is inflated. When the distal end portion 27 of the rod is formed into a shape other than an arrowhead shape, the fracture mode of the second rupturable plate 48 is different.

(2) Method for Assembling the Gas Generator Shown in FIG. 1 and FIG. 2

A method for assembling the gas generator shown in FIG. 1 and FIG. 2 will be explained below with reference to FIGS. 3(a) to (c). FIGS. 3(a) to (c) are partial cross-sectional views for explaining the assembling method.

The rod 24 and retainer 50 are integrated in advance and then press-inserted into the cylindrical housing 20.

A rod provided with the non-through section 27a having an outer diameter larger than the diameter of the orifice 56 of the retainer 50 and the through section 27b having an outer diameter smaller than the diameter of the orifice 56 is used as the rod 24 that is to be integrated with the retainer 50. A stepped surface 28a (first contact surface 28a of FIG. 1(b)) formed due to the difference in the outer diameters is present between the non-through section 27a and through section 27b.

As shown in FIG. 3(a), the through section 27b is inserted into the orifice 56. At this time, the stepped surface 28a abuts against the surface of the central supporting portion 55 having the orifice 56, and the non-through section 27a is positioned on the opposite side of the through section 27b.

Then, as shown in FIG. 3(b), the through section 27b is deformed by rolling-crimping such as to crush the through section 27b. Then, as shown in FIG. 3(c), rolling-crimping is continued to process the through section 27b so as to obtain the shape of an arrowhead. By such processing, the outer diameter of the through section 27b is made larger than the diameter of the orifice 56.

FIG. 3(c) illustrates the state identical to that shown in FIG. 1(b). The rod 24 and retainer 50 are integrated by sandwiching the central supporting portion 55 having the orifice 56 from both sides with the first contact surface 28a located on the non-through section 27a side and the second contact surface 28b located on the through section 27b side. Because the center of the orifice 56 and the center of the second rupturable plate 48 are directly opposite to each other, the center of the arrowhead like through section 27b and the center of the second rupturable plate 48 are also directly opposite to each other.

Then, the integrated rod 24 and retainer 50 are press-inserted from the open section in the diffuser portion 40 side into the cylindrical housing 20. At this time, the ignition device chamber housing 32 provided with the first rupturable plate 38 has been attached to the open section at one end side of the cylindrical housing.

The diffuser housing 42 is then welded and fixed to the open section at the other end of the cylindrical housing 20. At this time, when the diffuser housing 42 provided with the second rupturable plate 48 is attached to the open section at the other end of the cylindrical housing 20, the center of the arrowhead like through section 27b and the center of the second rupturable plate 48 are automatically disposed directly opposite to each other.

The distal end portion 27 of the rod becomes integrated with the retainer 50, and therefore, movement of the distal end portion in the axial direction or radial direction is prevented. The rod 26 is pressed towards the first rupturable plate 38 by the elasticity of the retainer 50, and the base end portion 25 of the rod is fixed so as to be pressed against the ignition device chamber housing 32. As a result, the disk portion 25 of the rod 24 is lightly fixed by the circumferential wall section 33a so as to prevent the disk portion from shifting in the radial direction, whereas the displacement in the axial direction is prevented by the retainer 50.

The igniter 36 is then attached, and the inner space 22 of the cylindrical housing 20 is filled with gas to obtain a predetermined pressure therein.

The rod 24 is pressed by the retainer 50 towards the first rupturable plate 38 and the retainer 50 is pressed by the rod 24 towards the second rupturable plate 48, thereby the rod 24 and retainer 50 are fixed inside the cylindrical housing 20 of the gas generator 10. As a result, the rod 24 and retainer 50 are prevented from shifting or falling-off. Furthermore, the rod 24 is disposed in a pressurized space, but because equal pressure is applied to all the surfaces of the rod 24, the movement of the rod 24 is not made difficult by the pressurized gas during actuation.

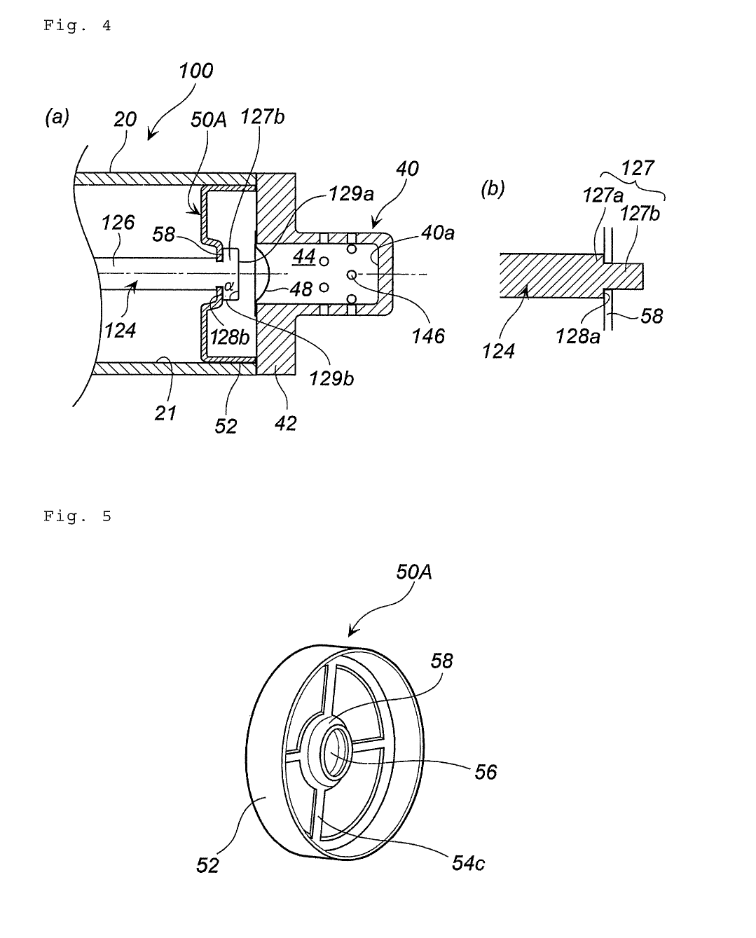

(3) Gas Generator Shown in FIG. 4 and FIG. 5

FIG. 4(a) is a vertical partial cross-sectional view of a gas generator 100 of another embodiment. FIG. 4(b) is a partial enlarged view of the configuration shown in FIG. 4(a) illustrating the state prior to integration with a retainer 50A. FIG. 5 is a perspective view of the retainer shown in FIG. 4(a). The gas generator 100 shown in FIG. 4 is identical to the gas generator 10 shown in FIG. 1, except that the shape of the distal end portion of a rod 124 and the shape of the retainer 50A are different from those of the gas generator shown in FIG. 1.

The retainer 50A is identical to the retainer shown in FIG. 2, except that the circumferential edge of the orifice 56 is raised and has an inward flange section (fragile portion) 58, as shown in FIG. 5.

As shown in FIG. 4(b), the rod 124 before it is integrated with the retainer 50A has a distal end portion 127, a non-through section 127a, a through section 127b, and a stepped surface 128a. The outer diameter of the non-through section 127a is larger than the diameter of the orifice 56, and the outer diameter of the through section 127b is less than the diameter of orifice 56. The outer diameters of a shaft portion 126 and the non-through section 127a are the same.

The retainer 50A and rod 124 are integrated by crimping a distal end surface 129a of the through section 127b so that it becomes a flat surface and by sandwiching the flange section 58 from both sides with the step section (first contact section) 128a and second contact section 128b to obtain a state shown in FIG. 4(a).

As shown in FIG. 4, the distal end surface 129a of the through section 127b is a flat surface, and a 90° angle (α in the drawing) is formed in the boundary portion with the side surface 129b. The angle can be formed by employing a processing method (cutting or the like) other than crimping. The outer diameter of the distal end surface 129a is slightly less than the inner diameter of the second channel 44, and the outer diameter of the shaft portion 126 (non-through section 127a) is sufficiently smaller than the inner diameter of the second channel 44.

The rod 124 and retainer 50A are thus sandwiched between the ignition device chamber housing and diffuser housing 42. Therefore, both the retainer 50A and the rod 124 are fixed in the predetermined positions, the displacement of the rod 124 under the effect of vibrations induced from the outside or the like is prevented, and the displacement and falling-off of the retainer 50A itself is prevented.

When the rod 124 moves and fractures the second rupturable plate 48 during the activation of the gas generator, because the rod distal end portion 127 has a flat surface (distal end surface) 129a, the second rupturable plate 48 is fractured by shearing and punched through, whereby fragments of about the same size as the distal end surface 129a are formed. The punched-out fragments are pressed by the distal end surface 129a to the bottom surface 40a of the diffuser portion 40 and held in this state. As a result, the discharge of pressurized gas is not hindered by the fragments.

When the distal end surface 129a is pressed against the bottom surface 40a, the shaft portion 126 is positioned inside the second channel 44, but because the outer diameter of the shaft portion 126 is sufficiently smaller than the inner diameter of the second channel 44, the gas channel is ensured and the discharge of pressurized gas is not hindered.

The invention thus described, it will be obvious that the same may be varied in many ways. Such variations are not to be regarded as a departure from the spirit and scope of the invention, and all such modifications as would be obvious to one skilled in the art are intended to be included with the scope of the following claims.

1. A gas generator for an restraining device for a vehicle comprising:
a cylindrical housing having two open sections;
an ignition device chamber connected to one open section of the cylindrical housing;
a diffuser portion connected to the other open section of the cylindrical housing and provided with a gas discharge port;
a first blockage member blocking between the cylindrical housing and the ignition device chamber;
a second blockage member blocking between the cylindrical housing and the diffuser portion;
pressurized gas charged inside the cylindrical housing;
a rod for breaking the second blockage member upon activation and opening a channel to the diffuser portion; and
the rod being disposed inside the cylindrical housing in the state that a base end portion of the rod contacts a wall surface in the vicinity of the first blockage member and a distal end portion of the rod is integrated with a retainer fitted into a position close to the second blockage member.

2. The gas generator for an restraining device for a vehicle according to claim 1, wherein the retainer has an orifice, the distal end portion of the rod has a through section that passes through the orifice and a non-through section that does not pass through the orifice, and a circumference of the orifice is sandwiched between the through section and the non-through section, thereby integrating the rod and the retainer.

3. The gas generator for an restraining device for a vehicle according to claim 1, wherein the retainer has an orifice, the distal end portion of the rod has a through section that passes through the orifice and a non-through section that does not pass through the orifice, an annular groove is formed between the through section and the non-through section, and a circumference of the orifice is inserted into the annular groove to integrate the rod and the retainer.

4. The gas generator for an retraining device for a vehicle according to claim 2, wherein the retainer is formed from a member having elastic properties, the rod is fixed in the state of having a base end portion thereof in contact with a wall surface in the vicinity of the first blockage member and being pressed against the wall surface in the vicinity of the first blockage member due to elastic deformation of the retainer, and the distal end portion of the rod and retainer are fixed by pressing against each other.

5. The gas generator for an restraining device for a vehicle according to claim 2, wherein the retainer has an annular frame portion, a plurality of rod-like supporting portions that extend from a peripheral edge on one end side of the annular frame portion toward the center, and a central supporting portion formed by the plurality of rod-like supporting portions, and the central supporting portion has an orifice in which the distal end portion of the rod is to be inserted.

6. A method of assembling the gas generator, comprising:
providing a cylindrical housing having two open sections;
connecting an ignition device chamber to one open section of the cylindrical housing, which includes a first blockage member blocking a first channel between the cylindrical housing and the ignition device chamber;
integrating a rod, which includes a base end portion formed at one end thereof and a distal end portion formed at the other end thereof, with a retainer that has an orifice and supports the distal end portion of the rod; and
providing the rod and the retainer within the cylindrical housing.

7. The method of assembling the gas generator, according to claim 6, wherein the step of integrating the rod with the retainer includes,
integrating the retainer and the rod that is provided with a non-through section having a diameter larger than a diameter of the orifice of the retainer, and through section having a diameter smaller than the diameter of the orifice;
inserting the through section into the orifice;
crimping the through section to sandwich a circumference of the orifice between the non-through section and the through section.
